(19) United States
(12) Patent Application Publication
(10) Pub. No.: US 2011/0052770 A1
(43) Pub. Date: Mar. 3, 2011

(54) INCLUSION/INCORPORATING VISCOUS MATERIAL INTO MUSCLE MEAT

(76) Inventor: Leo D. Perdersen, Danville, CA (US)

(21) Appl. No.: 12/553,767

(22) Filed: Sep. 3, 2009

(51) Int. Cl. A23L 1/325; A23L 1/31

(52) U.S. Cl. 426/281

(57) ABSTRACT

A method of increasing the mass of muscle meat, such as trimmed fish fillet or fish loin. As the invention pertains to fish products, up to approximately twenty percent of the muscle mass of the fish fillet or fish loin is removed during routine trimming operations which is ground to create a quantity of ground trimmings having a solids content of at least five percent by weight. The ground trimmings are fed to a volumetric chamber and injected within the trimmed fish fillet or fish loin to increase its mass in a form representing natural muscle flake

### TECHNICAL FIELD

A method and device for dispersing a viscous material into muscle meat. Viscous material is introduced into a volumetric chamber which is capable of passing a measured amount of the viscous material into an injection needle which, in turn, is inserted within the muscle meat. The needle is sized and configured to insert the measured amount of viscous material in a pattern resembling the surrounding muscle flake of the muscle meat.

### BACKGROUND OF THE INVENTION

In preparation of meat products the products are portioned and trimmed to meet the consumer's needs and desires. In these processes considerable amounts of the meat are discharged or underutilized due to the lack of size, form or thickness. In preparation of fish fillets, for example, trimming of the thin outer portion of a fillet and the rib cage accounts for 15 to 20% of the final fillet weight. In portion packs of, for example, salmon loin can typically be divided into three 4 ounce portions leaving a tail piece of two to four ounces, which is below the consumer's desired weight or with an undesirable shape. These meat residuals are identical to the marketed products but are lacking in appearance and consumer acceptance.

There is also a broader need to introduce viscous material into muscle meat not only for weight addition but also for flavorings or texture enhancement. Again, any such addition must not significantly detract from the appearance of an untreated product This need exists not only regarding seafood but also with regard to meat and poultry.

Various meat tenderizers, enzymes and applicators have been devised for inclusion of material for enhancing the weight, texture and flavor of seafoods, meats and poultry based foods. These applications and related applicators are generally designed for the insertion of low solids marinates and related substrates. Such devices are unable to handle viscous substrates of the types described previously. Certainly, the typical prior art marinate applicators are incapable of introducing injectates having a solids concentration greater than 5% by weight. This is because prior art devices employ narrow feed channels introducing marinates that are distributed through a common header to enable the marinade to feed through multiple injection heads to accommodate assemble-line like production.

It is thus an object of the present invention to provide a method and device for dispersing a viscous material into muscle meat.

It is a further object of the present invention to provide a method and device for injecting viscous material into muscle meat which, once introduced, replicates the muscle flake of the receiving body and is thus an imperceptible way to increase the product weight unbeknownst to a consumer. These and further objects will become readily apparent when considering the following disclosure and appended claims.

### SUMMARY OF THE INVENTION

The invention is directed to a method of increasing the muscle mass of a trimmed fish fillet comprising trimming approximately up to twenty percent of muscle mass from a fish fillet or fish loin, grinding up said trimmed muscle mass and removing any bones that may have been found therein to create ground trimmings, said ground trimmings having a solids content of at least five percent by weight introducing said ground trimmings to a volumetric chamber and injecting the ground trimmings from said volumetric chamber within said trimmed fish fillet or fish loin to increase the mass thereof.

The invention further is directed to a method of creating a plurality of fish portion packs each of which is of a substantially constant weight, said method comprising trimming a fillet of said fish, removing any bones that may be found therein to create ground trimmings, said ground trimmings having a solid content of at least five percent by weight, introducing said ground trimmings to a volumetric chamber in injecting the ground trimmings from said volumetric chamber within said fish fillet to result in fish fillets of substantially constant weight.

In addition, the invention is directed to a method of introducing an injectate into a portion of muscle meat, said injectate having a solids content of at least five percent by weight, said method comprising introducing said injectate to a volumetric chamber and injecting said injectate from said volumetric chamber within said muscle meat.

### BRIEF DESCRIPTION OF THE FIGURES

FIG. 1 is a schematic illustration of a device useful in carrying out the present method.

FIGS. 2a, 2b and 2c are side cross sectional views of a portion of the injection apparatus useful in carrying out the present method.

FIG. 3 is a side view of a preferred injection need which is useful in practicing the present method.

FIG. 4 is a block diagram showing the process carried out by employing the apparatus of FIG. 1.

### DETAILED DESCRIPTION OF THE INVENTION

In its preferred embodiment, the present invention is directed to a method of increasing the muscle mass of a trimmed fish fillet comprising trimming approximately up to twenty percent of muscle mass from a fish fillet or fish loin, grinding up the trimmed muscle mass and removing any bones that may have been found therein to create ground trimmings, said ground trimmings having a solids content of at least five percent by weight, introducing said ground trimmings to a volumetric chamber and injecting the ground trimmings from said volumetric chamber within said trimmed fish fillet or fish loin to increase the mass thereof.

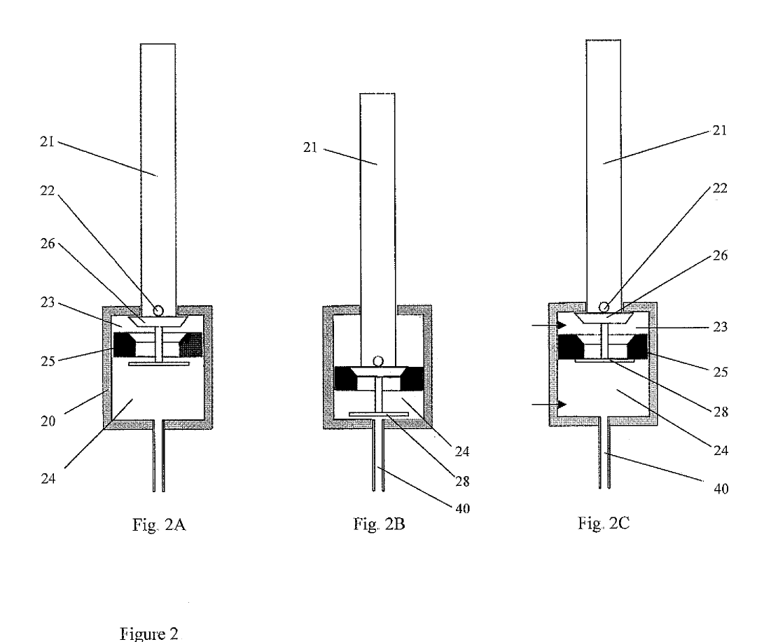

In carrying out the above-recited method, reference is made to FIG. 2. Specifically, a portion of the muscle mass trimmed from the fish fillet or fish loin is ground and an injectate having a solids content of at least five percent by weight is introduced through feed channel 22 emanating from piston rod 21 within upper chamber 23. In turning to FIG. 2b, once the appropriate volume, generally 0.5 to 5 grams of the ground trimmings pass through feed channel 22, they continue to pass through valve seat 25 and into lower chamber 24. As noted by reference to FIG. 2a, a clear path is established between feed channel 22 and lower chamber 24 during such operation.

Once the appropriate amount of ground trimmings or injectate have been introduced to volumetric chamber 20, piston rod 21 is moved downward causing valve seat 25 to close by virtue of the seating of valve 26 therein and material contained within lower chamber 24 is caused to pass through needle 40 and into the appropriate muscle meat. It is noted that the amount of ground trimmings or injectate passing through needle 40 can be precisely controlled by noting the volume of lower chamber 24 and realizing that the opening in needle 40 is controllably closed by virtue of barrier 28. After all of the material is in lower chamber 24 has been injected through needle 40, the process is reversed as shown in FIG. 2c whereby as piston rod 21 rises, barrier 28 blocks the lower portion of valve seat 25 and as piston rod 21 continues to rise, valve seat 25 moves upwardly and a vacuum is created in upper chamber 23 causing ground trimmings or injectate to be urged from feed channel 22 into upper chamber 23 in order to enable the process to be repeated as described above.

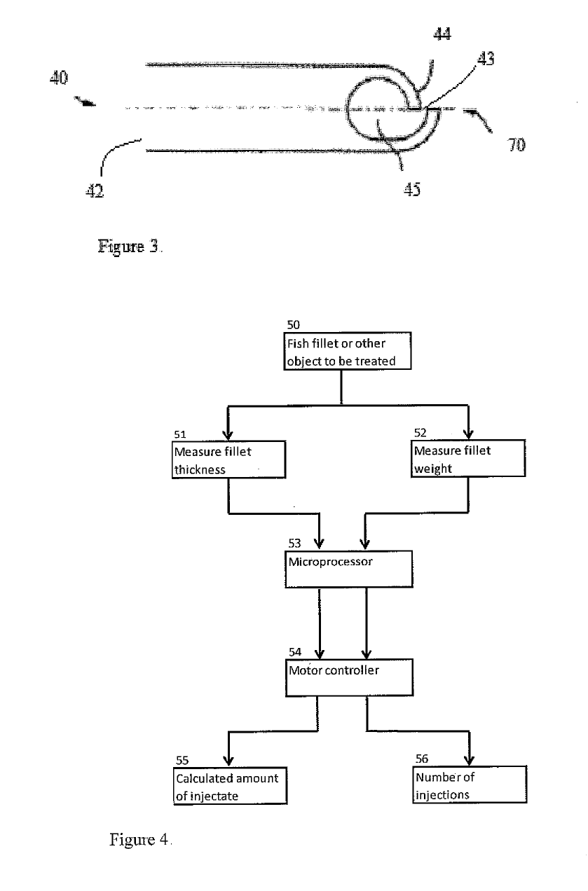

Ground trimmings or injectate entering needle 40 passes therethrough and, in this regard, reference is made to FIG. 3.

To facilitate the appropriate dispersion of the injectate into the muscle meat, and ideally to do so as muscle flake, a specific injection needle is provided. In this regard, reference is made to FIG. 3. This needle design can inject a volume equal to the amount dictated by other factors in a way to simulate muscle flake which will be discussed below. For example, in dealing with a fish fillet, larger muscle flake is deposited near the head of the fillet while lesser amounts near its tail. The needle is self cleaning and resistant to plugging by muscle fiber, tendons and “string” material. The needle must also be able to handle highly viscous material such as coarsely ground fish trimmings being at least five percent by weight solids.

Injection needle 40 is depicted in the form of a cylinder having longitudinal axis 70 and includes material receiving end 42 and viscous material dispersing end 43. In its ideal configuration, injection needle 40 is provided with portion 44 acting to substantially block dispersing end 43 along longitudinal axis 70 while being provided with openings 45 in the needle side wall to substantially inject the viscous material into the muscle meat in a pattern resembling surrounding muscle flake. Such a needle design can form new muscle flake through injection in a double horizontal pattern.

The preferred use of the present invention is to increase or supplement the mass of a fish fillet or fish loin by injecting trimmings of the same fish matter within and between the muscle flake of the fillet or loin. Oftentimes, the portion of the fillet or loin is trimmed away at its tail section resulting in the removal of ten to twenty percent of the muscle meat. Bones are removed from these trimmings and the removed portion ground for injection within the remaining fillet or loin to increase its weight. The quantity of ground trimmings injected back within the trimmed fillet or loin is oftentimes dictated by several factors. The first factor is the thickness of the fillet or loin noting that the thicker the fish portion, the more ground trimmings the fillet or loin can receive. Also, seafood products are often sold in “portion packs” where uniform serving sizes of individual portions is critical. Thus, the quantity of injectate can be dictated by the weight of the seafood product to be enhanced to achieve the proper “portion pack” mass.

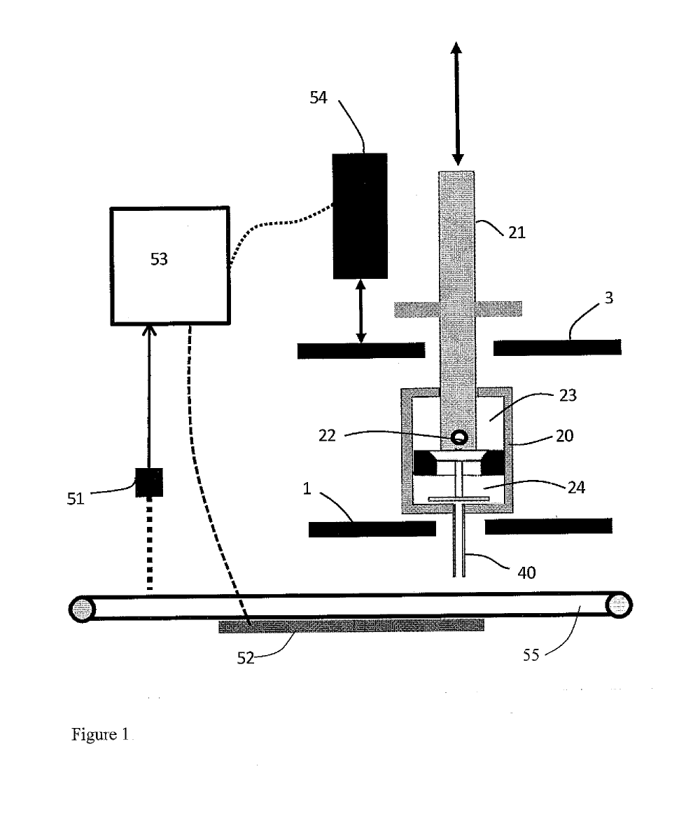

The present invention can be carried out by following the flow diagram 50 of FIG. 4. Specifically, the trimmed fish fillet or loin can either be measured for thickness through the use of a laser 51 or mass (weight) to develop the appropriate “portion pack” by scale 52. This information is then fed to microprocessor 53 which then sends an actuation signal to motor controller 54 which in turn moves frame 3 (FIG. 1) downwards to increase the relative amount of injectate or moves frame 3 upwards if less injectate is required by the user. Thus, the present process can be automated though the use of a scale or laser to determine weight or thickness of the muscle meat which is intended to be enhanced by the introduction of a suitable amount of injectate to simulate a muscle flake.

In turning to FIG. 1, a schematic of the device useful in practicing the steps of FIG. 5 is depicted. Specifically, the device combines several individual operations, the first being to adjust the bridge 1 to allow piston 21 and injection cylinder 20 to move as a unit causing needle 40 to be inserted into the object to be treated on the conveyor belt 55. When the injection cylinder reaches bridge 1, further downward movement of the injection cylinder is stopped and needle 40 is in its injection position. Further downward movement of piston 21 causes injectate located within lower chamber 24 to be discharged through needle 40. Simultaneously, a vacuum is created in upper chamber 23 causing new injectate to be drawn down hollow piston rod 21 and through feed port 22 filing upper chamber 23.

During the upstroke of piston 21, needle 40 is removed from the treated product until injection cylinder 20 comes to rest against cross plate 3 at which point the needle is fully retracted. In the second phase of the upstroke, valve 26 disengages from valve seat 25 facilitating the flow of injectate from upper chamber 23 across stopper bar 28 and into lower chamber 24.

It is recognized that, currently, injections involving marinades and other injectates is widely used in the meat, poultry and seafood industries. Such technology is characterized by the utilization of a large number of injector needles applied in a close pattern to disguise or provide a uniform distribution of the injectates throughout the product. This is unlike the present invention which enables a user to preselect a specific volume of injectate similar to the size of the individual muscle flakes which is placed between the natural muscle flake structure of, for example, a suitable fish fillet or loin. Prior techniques have been restricted to injectates of low viscosity to prevent clogging of the apparatus. By contrast, the present invention can incorporate fish muscle and other injectates that has only been subjected to coarse titration. This invention does not decrease the firmness of the muscle meat not increase drip or cooking losses associated with injectates of low viscosity. As noted previously, the present invention is ideally suited for increasing the mass of a fish fillet or fish loin to incorporate trimmings back within the trimmed product to increase its mass and to employ trimmings which otherwise would have been discarded. In the fillet preparation, achieving the desired appearance oftentimes involves removal of 10 to 20% of muscle meat. The trimmings are identical to the final fillet or loin but do not have the requited thickness or contain bones. These trimmings are incorporated back into the fish fillet or loin product.

Although applicant has described the present invention in terms of its preferred embodiment, that is, the reintroduction of ground trimmings taken from a fish fillet or loin and injecting them back within the fish product between existing muscle flake to create additional muscle flake virtually indistinguishable from the trimmed fillet or loin, the invention can be used to inject flavoring and texture enhancers such as partially dried or other water binding substrates to alter firmness and texture of the nontreated product. Injection needle 40 is ideally provided with an internal diameter of 2 to 6 mm receiving measured amounts of the viscous material from volumetric chamber 20. Injection needle 40 can apply viscous material from 30 to 90 degrees to the surface of the muscle meat in injectate volumes, generally, of 0.2 to 5 grams per injection. The injection of particular meat products, such as fish trimmings, can have high solids content from 5 to 100% of the injectate. Dispersion patterns can be determined by regulation of the plunger velocity and needle tip configuration. Ideally, the viscous material is dispersed in the muscle meat at a pressure above 4 bar and at a rate of approximately 1 gram per second.

What is claimed is:

1. A method of increasing the muscle mass of a trimmed fish fillet comprising trimming approximately up to twenty percent of muscle mass from a fish fillet or fish loin, grinding up the trimmed portion of said muscle mass and removing any bones that may have been found therein to create ground trimmings, said ground trimmings having a solids content of at least five percent by weight, introducing said ground trimmings to a volumetric chamber and injecting the ground trimmings from said volumetric chamber within said trimmed fish fillet or fish loin to increase the mass thereof.

2. The method of claim 1 wherein said volumetric chamber is sized to deliver approximately 0.2 to 5 grams of said ground trimmings to said trimmed fish fillet or fish loin.

3. The method of claim 2 wherein the quantity of said ground trimmings delivered from said volumetric chamber is proportional to the thickness of said trimmed fish fillet or fish loin.

4. The method of claim 1 wherein said ground trimmings are fed from said volumetric chamber through an injection needle, said injection needle comprising a cylinder having a longitudinal axis, a receiving end and dispersing end, said dispersing end being embedded within said fish fillet or fish loin, said injection needle having a portion substantially blocking said dispersing end at said longitudinal axis and having openings in its side walls to substantially inject said ground trimmings into said fish fillet or fish loin in a pattern resembling muscle flake of said fish fillet or fish loin.

5. The method of claim 4 wherein said ground trimmings are injected between muscle flakes of said fish fillet or fish loin.

6. A method of creating a plurality of fish portion packs each of which is of a substantially constant weight, said method comprising trimming a fillet of said fish, removing any bones that may be found therein to create ground trimmings, said ground trimmings having a solid content of at least five percent by weight, introducing said ground trimmings to a volumetric chamber and injecting the ground trimmings from said volumetric chamber to within said fish fillet to result in substantially constant weight

7. The method of claim 6 wherein said volumetric chamber is sized to deliver approximately 0.2 to 5 grams of said ground trimmings to said trimmed fish fillet.

8. The method of claim 6 wherein said ground trimmings are fed from said volumetric chamber through an injection needle, said injection needle comprising a cylinder having a longitudinal axis, a receiving end and a dispel sing end, said dispel sing end being embedded within said fish fillet, said injection needle having a portion substantially blocking said dispersing end at said longitudinal axis and having openings in its side wall to substantially inject said ground trimmings into said fish fillet in a pattern resembling muscle flake of said fish fillet.

9. A method of introducing an injectate into a portion of muscle meat, said injectate having a solids content of at least five percent by weight, said method comprising introducing said injectate to a volumetric chamber and injecting said injectate from said volumetric chamber within said muscle meat.

10. The method of claim 9 wherein said volumetric chamber is sized to deliver approximately 0.2 to 5 grams of said injectate to said muscle meat.

11. The method of claim 10 wherein the quantity of said injectate delivered from said volumetric chamber is proportional to the thickness of said muscle meat.

12. The method of claim 9 wherein said injectate is fed from said volumetric chamber through an injection needle, said injection needle comprising a cylinder having a longitudinal axis, receiving end and dispersing end, said dispersing end being embedded within said muscle meat, said injection needle having a portion substantially blocking said dispersing end at said longitudinal axis and having openings in its side wall to substantially inject said injectate into said muscle meat in a pattern resembling muscle flake.
